(19) United States
(12) Patent Application Publication
(10) Pub. No.: US 2005/0251447 A1
(43) Pub. Date: Nov. 10, 2005

(54) Promotional methods involving the use of tokens

(76) Inventor: Karen Nixon Lane, Plymouth, MI (US)

Correspondence Address: BUTZEL LONG, 350 SOUTH MAIN STREET, SUITE 300, ANN ARBOR, MI, 48104, US

(21) Appl. No.: 11/104,585

(22) Filed: Apr. 11, 2005

Related U.S. Application Data
(60) Provisional application No. 60/561,409, filed on Apr. 12, 2004.
(60) Provisional application No. 60/624,911, filed on Nov. 4, 2004.
(60) Provisional application No. 60/638,877, filed on Dec. 23, 2004.

(51) Int. Cl. G06F 17/60

(52) U.S. Cl. 705/14

(57) ABSTRACT

A business method of promoting a commercial activity which involves identifying customers to be attracted to the commercial activity, distributing at least one token to each of the identified customers, each of the distributed tokens having a true cash value within the situs where the commercial activity takes place and allowing the identified customers to which the tokens are distributed to participate in the commercial activity within the situs. The tokens can also be provided with serialized data which can be collected and recorded when the tokens are distributed and collected using imaging technology. The recorded data can be used to determine and develop marketing strategies based on the manner in which the tokens were distributed and dispersed.

### RELATED APPLICATIONS

This application is related to U.S. Provisional Patent Application Ser. No. 60/561,409 entitled “Gift Package Assembly”, filed Apr. 12, 2004, Provisional Patent Application Ser. No. 60/624,911 entitled “Gift Package Assembly and Promotional Method,” filed Nov. 4, 2004, and U.S. Provisional Patent Application Ser. No. 60/638,877 entitled “Collection of Serialization Data Applied to Tokens Using Computerized Machine Vision”, filed Dec. 23, 2004.

### TECHNICAL FIELD

The present invention relates to business methods for promoting various commercial activities. More particularly, the present invention relates to data serialized tokens and their use in promotional business methods and methods of reading and processing the data from the tokens.

### BACKGROUND ART

activity may not be suitable for other types of commercial activities. For example, casinos can offer discounts for lodging, meals or drinks, but they typically do not offer discounts for participation in their gaming activities.

Current commercial promotional methods lack the ability to track, accumulate and process data that is related to the success of such promotions. Commercial enterprises may track the general increase in activity following a promotion or request and collect general information such as zip codes or phone numbers from customers after a promotion. However, the ability to accurately to track, accumulate and process data that is related to the success of such promotions is unfulfilled.

The present invention provides a method of accurately tracking, accumulating and processing data related to promotional activity using data serialized tokens in conjunction with methods of reading and processing the data from the tokens.

### DISCLOSURE OF THE INVENTION

According to various features, characteristics and embodiments of the present invention which will become apparent as the description thereof proceeds, the present invention provides a method of promoting a commercial activity which involves the steps of:

a) identifying customers to attract to a commercial activity;

b) distributing at least one token to each of the identified customers, each of said distributed tokens having a true cash value and being substantially identical to similar tokens used as cash within the situs where the commercial activity takes place; and

c) allowing the identified customers to which the tokens are distributed to participate in the commercial activity within the situs.

The present invention further provides a method of promoting a commercial activity which involves the steps of:

a) identifying customers to attract to a commercial activity;

b) distributing at least one token to each of the identified customers, each of said distributed tokens provided with serialized data and being exchangeable for value for the commercial;

c) allowing the identified customers to which the tokens are distributed to participate in the commercial activity; and

d) recording the serialized data provided on the tokens in steps b) and c) and correlating information regarding the distribution and collection of the individual tokens.

The present invention also provides a system for obtaining data applied to tokens which includes:

a mechanical system for receiving and presenting tokens to an imaging station;

an imaging system for capturing images of the tokens when they are positioned at the imaging station; and

a data processor for receiving images of the tokens from the imaging system and identifying the data that is applied to the tokens; and

means for storing and correlating the identified data.

The present invention also provides a method of tracking the dispersement and use of tokens that having tracking data applied there to which involves the steps of:

obtaining tokens that were distributed and dispersed;

feeding the obtained tokens into a mechanical system that presents the tokens to an imaging station;

capturing images of the tokens when they are positioned at the imaging station;

sending the captured images of the tokens to a data processor and identifying the data that is applied to the tokens; and

correlating the identified data to determine and develop marketing strategies based on the manner in which the tokens were distributed and dispersed.

### BRIEF DESCRIPTION OF DRAWINGS

The present invention will be described with reference to the attached drawings which are given as non-limiting examples only, in which:

FIG. 1 is a diagram of a system that can be used to visually detect, collect, store and process data from a token according to one embodiment of the present invention.

FIG. 2 is an exploded perspective view of a gift package assembly according to one embodiment of the present invention.

FIG. 3 is an exploded perspective view of a gift package assembly according to another embodiment of the present invention.

FIGS. 4A-1 to 4F-2 are top and side elevational views of various design alternatives of the gift package assembly of the present invention.

FIG. 5 is a schematic view of a gift tag for use with the gift package assembly of FIGS. 2 to 4F-2.

FIG. 6 is a schematic view of a ribbon member for use with the gift package assembly of FIGS. 2 to 4F-2.

### BEST MODE FOR CARRYING OUT THE INVENTION

The present invention is directed to data serialized tokens and their use in promotional business methods and methods of reading and processing the data from the tokens. According to one aspect of the present invention the serialized tokens are used in a business method for motivating potential and/or repeat customers to engage in gaming activities in a casino. The method involves providing potential and/or repeat customers with tokens that are the equivalent of cash and which have identification data incorporated thereon and/or therein. Such tokens can be provide to potential and/or repeat customers through any type of promotional offering, including but not limited to, mailings which include the tokens, vacation and/or travel packages in which the tokens are provided by travel agents, airlines, etc., promotional events such as sporting events, store events and the like in which the tokens are given to potential and/or repeat customers, and other promotional methods and activities.

According to one embodiment, the tokens are the equivalent of cash because they have a face value and are the actual “cash” that is used in a particular casino. This equivalent of cash feature is distinguishable from promotional programs in which coupons, certificates, credit vouches, etc. are used which have to be exchanged for the actual “cash,” i.e., poker chips, slot machine tokens, etc. before they can be used as actual cash in casinos (and which often have a very limited or no cash value within or out side of the casino). This “in-house” currency or cash (e.g., poker chips, slot machine tokens, etc.) used according to the present invention can be conveniently used by potential and/or repeat customers to engage in gaming activities such as slot machines, poker tables, backjack tables, etc. This ease of use and “in-house” value together with the potential to win at gaming activities will encourage and motivate potential and/or repeat customers to enter a casino and engage in gaming activities. As a result, the likelihood that the potential and/or repeat customers will continue to engage in the gaming activities after they have spent their promotionally given “cash” will cause them to spend more of their own money in the casino. Of course, the potential and/or repeat customers are free to merely “cash-in” their promotionally given tokens as they would any other poker chips, slot machine tokens, etc. that are used in casinos.

The fact that each casino has its own unique currency (i.e. poker chips, slot machine tokens, etc.) that is the equivalent of cash in-house, will cause the potential and/or repeat customers to enter a particular casino and engage in gaming activities. Accordingly, business method of the present invention involves enticing or motivating potential and/or repeat customers to enter a particular casino out of a group of casinos in a given location, by providing the potential and/or repeat customers with poker chips, slot machine tokens, etc, of the particular casino.

The tokens can be redeemable or non-redeemable as discussed herein and can be distributed and give out in a variety of packaging designs which are discussed herein

According to another embodiment of the present invention the tokens are redeemable or exchangeable for value at a situs or facility such as a casino, retail shop, restaurant, or other commercial or non-commercial business. For example, the tokens can be taken to a casino and exchanged for private casino tokens or chips that are used in the casino. In another example the tokens can be taken to a commercial retail establishment and exchanged for merchandise or commercial credit.

In the embodiment in which the tokens are redeemed or exchanged, and optionally in the embodiment in which the tokens are the equivalent of cash, the tokens are provided with serialized data which allows the circulation and use of the tokens to be tracked or monitored either manually or electronically, using for example, the apparatus for detecting, processing, collecting, and managing serialization data applied to tokens as discussed below.

According to another aspect if the present invention methods and apparatus for detecting, processing, collecting, and managing serialization data applied to tokens are provided. The over all system uses commercial, off the shelf hardware and software generically referred to as computer-based machine vision. The system is designed to be flexible, both in physical configuration as well as resulting data provided. The primary application of the system (although not limited thereto) is for the collection of marketing feedback data based upon promotion-encoded tokens that can be distributed to customers and then collected. Other applications can be based upon using the collected data in any manner such as, for example, tracking gaming trends as a function of various variables such as economy, geographic populace, etc. Similar applications involve the collection of data and the determination therefrom of the success of a promotional method that involves distribution of the tokens.

Using a standard manufacturing method, metallic tokens can be produced according to the present invention which will have unique serial number or batch data applied to one or more areas. The data may be applied by a number of processes depending upon the style, material, or aesthetics of design. Stamping, raised, color or color patterns, hot-stamping, pin-stamping are all non-limiting examples of possible methods well-understood in manufacturing.

It is not necessary for the data to be numeric in nature. It must simply be capable of representing the detail resolution required by the end customer. Various machine readable coding techniques are available including hexadecimal, base ten, graphic, gray encoding, binary, etc. If batch data is the highest level required, then simple graphic design features can be utilized to categorize the token.

Any material such as plastic, cast metal, stamped metal, or forged metals or metallic alloys, wood, etc. can be used to produce tokens for purposes of the present invention. In addition, any overall or patterned color or surface texture can be applied or provided on the tokens.

The system as described herein and used according to the present invention can be applied into existing token handling equipment that is currently in use, but only used to verify, count and sort tokens. In order to be used according to the present invention, existing token handling equipment can be modified to include and accommodate vision sensors. Depending upon design, it is necessary to provide an unobstructed view of the area of token bearing the encoding. If the machine is capable of orienting the token to a given “face up” condition, access only to that face will be required. Otherwise, a view of both sides of the token can be provided by mechanically manipulating the token. Radial location of the token is not necessary, as conventional vision inspection software is capable of orienting the image based upon token features. A variety of conventional vision sensors and lighting devices are available to suit a large variance in the possibilities for integration into existing token handling machines.

This machine vision methods and apparatus used according to the present invention can include existing commercial off the shelf (COTS) components. The machine vision industry has been maturing from its origins in the early 1980's and with the proliferation of large-scale silicon integration and application-specific chip design, there is an abundance of commercially available vision hardware available and can be used according to the present invention. Application of such commercially available vision hardware for purposes of the present invention is relatively straightforward, especially to those skilled in the art.

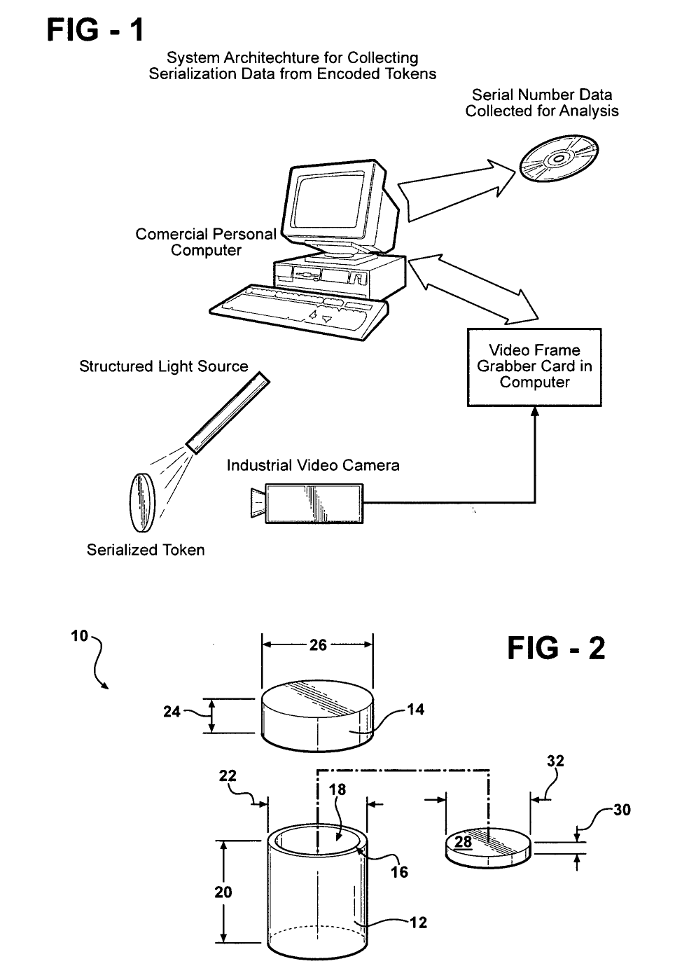

FIG. 1 depicts the basic component of a vision system that can be used according to the present invention. The main components include an optical system that includes any necessary light or illumination source to illuminate a token, a camera and suitable lens system to capture an electronic image of one or both sides of the token. An imaging processor and storage system and computer that can analyze collected data.

Cameras that can be used in the present system include small, monochrome, CCD chip or CMOS cameras. Such cameras can be quite compact, i.e. on the order or 30 mm×30 mm×30 mm and even smaller, which allows them to be easily integrated into existing token handling apparatus. A variety of camera technologies and interface schemes are currently available and can be used in the vision system of the present invention. Firewire, 1394, RS-232, digital or analog monochrome or color are all useable and transparent to this application.

A variety of lens and lens systems that are compatible with the image cameras referred to above which can be easily incorporated and aligned in the vision system to obtain images of the tokens. The lens and/or lens system can be chosen that is compatible with a given camera and which can produce a desired physical field of view and meet any desired resolution requirement.

Any long-life, structured light source and delivery system can be used in the vision system of the present invention. LED illumination is particularly useful according to the present invention due to its low heat generation and subsequent long life. However, light systems that use fiberoptic delivery of any monochromatic or multi-chromatic light source can also be used and are easily adoptable for used in existing token handling equipment. Means for isolating the token imaging system from ambient lighting variations can be incorporated to greatly simplify the lighting requirement. Such isolation means can simply be the housing of an existing token handling machine.

Either an internal or external power supply can be used to supply electrical energy for the camera and light source.

An image processing card, commonly referred to as a frame grabber, can be plugged in to a standard commercial computer and used to obtain token images from the camera and forward the images (as electrical signals) to the computer for storage and analysis. The imaging processing card will include associated software drivers which can be chosen so as to be compatible with any particular vision application software and the computer bus architecture chosen. PXI bus, PCI bus, USB, and Firewire products are examples of known architectural styles. The image processing card produces a digital file representing the image seen by the camera. The card can be triggered externally by the presence of a subject token in the inspection location. The triggering event can be a magnetic, infrared, or visible light proximity sensor that generates a trigger signal telling the system that a token is in place to be imaged. Image rates in similar applications for token sorters can be as high as five tokens per second.

All of the hardware described for use in conjunction with the present invention can be used with commercial PC-style computers. High speed vision processing has been greatly enhanced today by inexpensive Gigahertz-plus clock rates available on virtually all new PC's. Any necessary variations on hardware packaging and bus extensions like PXI and PCI bus extensions involve simply choices for compatibility to any existing design and hardware environment. Additional use of data exchange capabilities like USB, Ethernet, Firewire, etc. are incidental to the overall application.

Other than a standard computer operating system and data handling applications, a conventional vision-processing application is required. Through a software driver, the application acquires image data from the frame grabber card and camera. Various internal functions allow the image to be oriented and filtered to a consistent position and image density. The primary function can be carried out using Optical Character Recognition (OCR). OCR is a user tool resident within many commercially available vision processing packages. It is the same application that allows document scanning into an image that is a searchable, editable, data-file. In the present application, the OCR is used to convert the serialization data imaged from the tokens data files on the computer. These files, once created, can be subsequently processed for dates, data, and time of acquisition and is the essential product of this system. Using industry-standard data file structure, the data can be provided to the end user in a format that is easily transported and analyzed. The vehicle chosen for this delivery of data as well as the specific software chosen for the OCR and vision processing is simply a choice based upon system compatibility and ability to perform the task.

The technology used in the present invention is relatively straightforward although the application has it relates to serialized data applied to tokens and how the data is used is believed to be novel. For imaging purposes the tokens can be presented in a consistent lateral position/location utilizing existing coin handling equipment. The environment is isolated from external lighting variation since it is totally enclosed and the environment is relatively clean and mist-free. The serialized data can be any imagable or detectable feature applied to or incorporated into the tokens. All of these conditions contribute to make the system robust, error-free, and user friendly.

It is anticipated that the regular user of the apparatus/system would require no knowledge of the system. Technicians trained to adjust and repair the token handling machine would be trained to use special alignment and testing utilities to verify and adjust the improper operation of the vision system components. The computer host system would be configured to automatically turn-on, start-up, and run without operator input. The fact that it is a standard PC would be invisible to the casual operator/user.

With the widespread availability of web-enabled applications, the transfer of data, regular troubleshooting, or verification of the system can be accomplished remotely utilizing standard web-based communications applications and systems.

The components of the vision system and data capture and processing can be easily integrated into existing token handling machines.

Due to the ready availability of a wide range of hardware and software, from a large number of competitive suppliers, the actual selection and interconnection of specific hardware and application software is incidental to the unique nature of the end product—the collection of serialized data from individual tokens.

As noted herein the tokens can be made from metal, metal laminates, plastic materials, wood, etc. As used herein “tokens” refers to gaming tokens such as slot machine tokens, poker chips and other casino-type tokens as well as promotional tokens that encompasses various coin-type pieces that may or may not have a face or cash value. Further as used herein “tokens” can include non-coin-type tokens which can have shapes other than round coin shapes and even card shapes. The only requirement for such non-coin-type tokens is that they are provided with serialized data and that they are sufficiently durable to be distributed, circulated, collected and preferably re-distributed, re-circulated, recollected more than once.

According to one aspect of the present invention the tokens can be distributed in gift package assemblies.

FIG. 2 is an exploded view of a gift package assembly according to one embodiment of the present invention. The gift package assembly 10 depicted in FIG. 2 includes a receiver or first portion 12 and a cap or second portion 14. The first portion 12 is preferably a generally cylindrical shaped member having a circular cross section and having an opening 16 at an upper portion thereof and defining and enclosing an interior area 18 thereof. Alternatively, the first portion 12 is rectangular, square, triangular in cross section, discussed in more detail below, or could have any other desired cross sectional shape. The interior area 18 has a predetermined size, such as being determined by a length 20 and a diameter 22 of the first portion. The second portion 14 is preferably a generally disk-shaped member that has a predetermined size, such as being determined by a length 24 and a diameter 26 thereof for enclosing the opening 16 of the first portion 12. Preferably, the diameter 26 of the second portion 14 is slightly larger than the diameter 22 of the first portion 12 such that the second portion 14 completely encloses the opening 16 when the portions 12 and 14 are attached to form the assembly 10.

A gift portion, member or token 28 is sized to pass through the opening 16 of the first portion 12 and be received in the interior area 18 of the first portion 12. The gift token 28 has a predetermined size, such as being determined by a length 30 and a diameter 32 thereof. Preferably, the gift token 28 has the same cross sectional shape of the first portion 12, such as a circular cross section as shown in FIG. 2. Alternatively, the gift token 28 has a different cross sectional shape than the first portion 12, but is sized to fit through the opening 16 and be received in the area 18 of the first portion 12. While only one gift token 28 is shown in FIG. 2, those skilled in the art will appreciate that the first portion 12 of the assembly may be sized to receive more than one gift token 28. The gift token 28, may be, but is not limited to, a casino token, customer appreciation gift, a casino promotional item such as a slot machine token and/or poker chip, a souvenir item, a decorative item, jewelry, and other collector items that are sized to be disposed in the first portion 12 of the assembly 10.

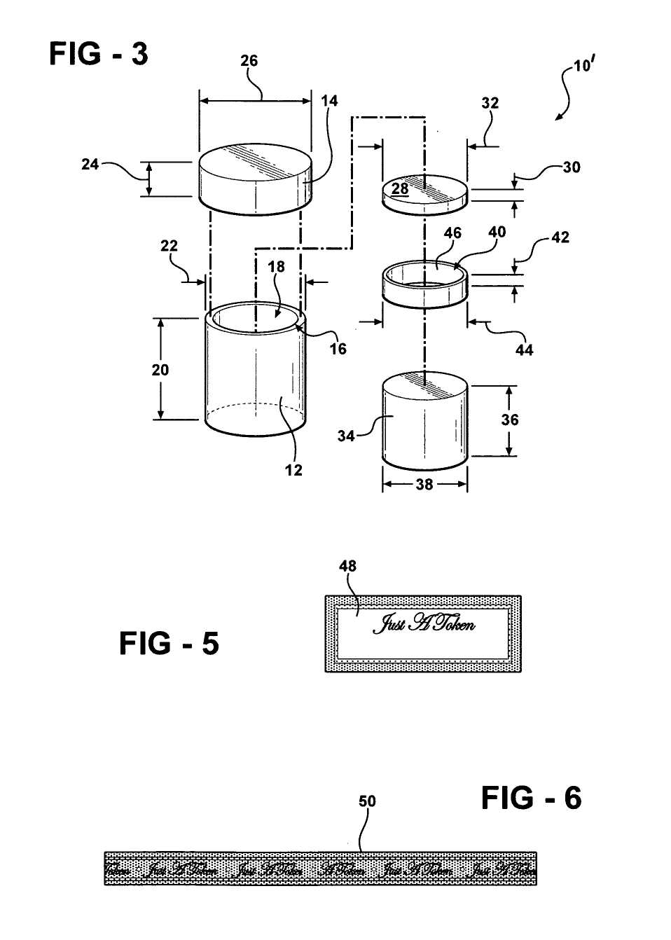

FIG. 3 is an alternative embodiment of a gift package assembly that is generally identified by reference numeral 10′. The gift package assembly 10′ includes an insert member 34 that is adapted to be disposed in the opening 16 of the first portion 12 and to fit in the interior area 18 of the first portion 12. The insert member 34 has a predetermined size, such as being determined by a length 36 and a diameter 38 thereof. The insert member 34 occupies more space in the interior area 18 of the first portion 12 to allow for a more snug fit when the gift token 28 is disposed therein. The gift package assembly 10′ includes a cone portion 40 that is adapted to be disposed and closely fit adjacent an upper edge of the opening 16 of the first portion 12. The cone portion 40 has a predetermined size, such as being determined by a length 42 and a diameter 44 thereof. An inner surface 46 of the cone portion 40 is tapered inwardly from an upper surface to a lower surface thereof to allow for easier insertion of the gift token 28 into the first portion 12. Preferably, the cone portion 40 is able to fit in the first portion 12 regardless of whether or not the insert member 34 is disposed in the first portion 12. Those skilled in the art will appreciate that only one or both of the insert member 34 and the cone portion 40 may be a part of the gift package assembly 10′.

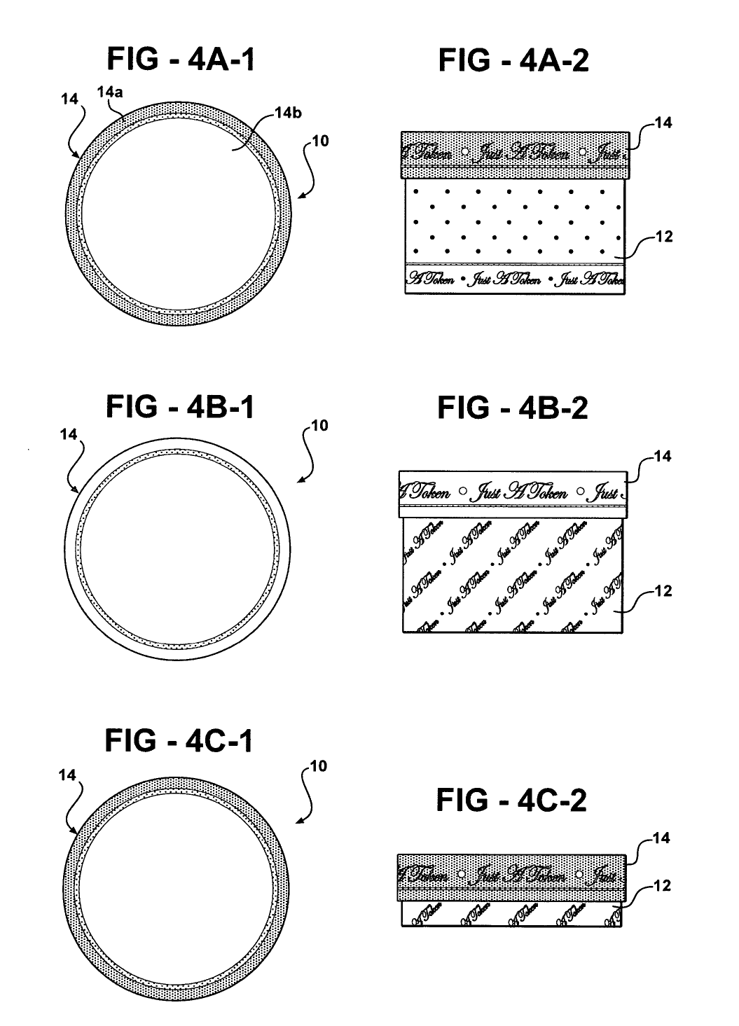

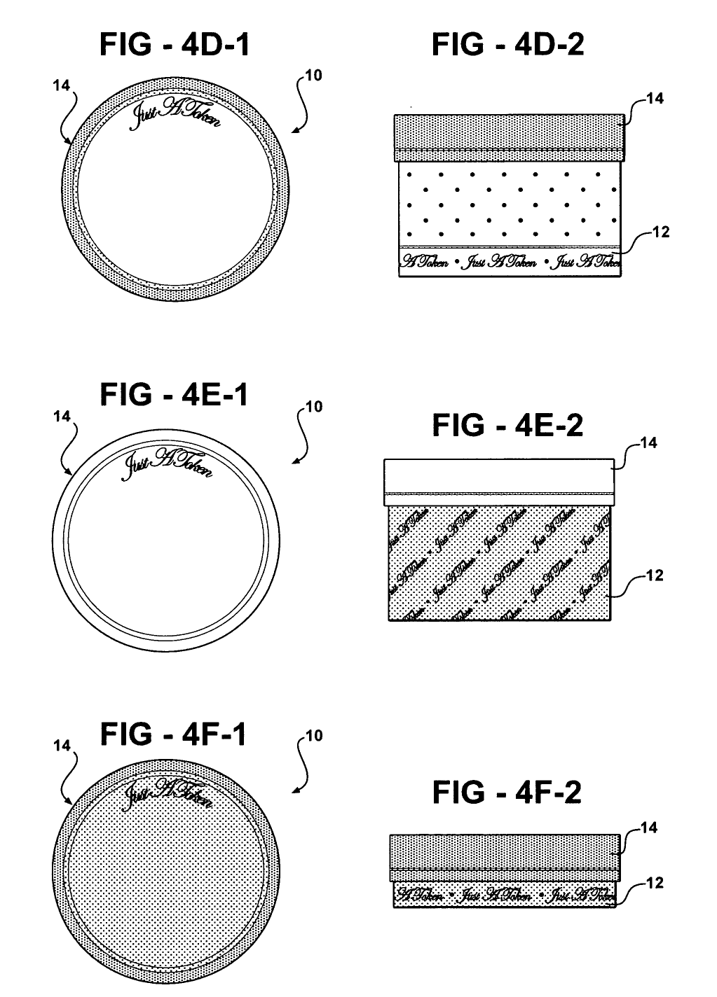

FIGS. 4A-1 to 4F-2 depict a number of various exterior designs for the assembly 10. The assemblies 10 include various designs on the respective exterior surfaces of the first portions 12 and the second portions 14. In particular, the overall length (the length 20 of the first portions 12 and the length 24 of the second portions 14 minus the depth of engagement (not shown) between the first portions 12 and the second portions 14 of the assemblies 10 shown in FIGS. 4C-1, 4C-2, 4F-1 and 4F-2 is less than the overall length of the assemblies 10 shown in FIGS. 4A-1, 4A-2, 4B-1, 4B-2, 4D-1, 4D-2. 4E-1 and 4E-2.

In addition, a decorative gift tag 48, best seen in FIG. 5, or a decorative ribbon member 50, as best seen in FIG. 5, may be attached to the assembly 10 or 10′ to aid in furthering a pleasing presentation for the assembly 10 or 10′. The respective exterior surfaces of the gift tag 48 and the ribbon member 50 preferably include the same design as the respective exterior surfaces of the first portions 12 and the second portions 14 shown in FIGS. 4A-1 through 4F-2. Alternatively, the exterior surfaces of the gift tag 48 and the ribbon member 50 include any type of complementary design.

The second portion 14 of the assembly 10 can include a distinctive, decorative ring portion 14a having a predetermined width that is embossed and/or imprinted into an upper surface of the second portion 14. The ring portion 14a, in effect, separates a center portion 14b on the upper surface of the second portion 14 from the remaining surfaces (i.e., top, sides, and reverse) of the second portion 14. The center portion 14b may be used to display a monogram or logo for a specific occasion or collection, such as a holiday assortment, casinos of the world, etc.

One feature of the second portion 14 is that the inside diameter of the decorative ring 14a will approximate the outside diameter of the token 28, such as a gaming token, thus reserving the ring portion 14a for commercial use, custom imprinting, licensing, advertising, etc. or the center portion 14b or “inner circle” to other corporations (e.g. casinos, without disturbing the inherent design of the assembly 10 or 10′. The remaining area of the second portion 14 will preferably be consistent in color, style, design, marking, etc. with the body of the first portion 12.

Alternatively, the assembly 10 does not include a first portion 12 and a second portion 14 but is instead replaced by a mini jewelry bag or the like with a drawstring closure (not shown) and a tag, such as the gift tag 48 or a ribbon, such as the ribbon member 50, attached thereto.

The “Just a Token” phrase shown in FIGS. 4A-1 to 4F-2 is a slogan that is intended to combine common gaming tokens (slot machine tokens/poker chips, etc.) with a unique marketable product and a promotional concept. The general concept can be used in at least two ways.

According to one aspect a variety of tokens (i.e., from different casinos, in various denominations) can be offered for purchase in a variety of packaging designs, to suit different themes, holidays, casinos, etc. In this concept the gaming tokens, in effect, can be used as gift certificates that are redeemable at the casino from which they originate.

According to another aspect, the package assemblies can be provided in various designs, themes (holidays, casinos, etc.) and offered for purchase as stand-alone items. The customer has the option to purchase the gaming tokens of his or her choice (i.e., from a casino, in any denomination) and package the tokens in the package assemblies.

In addition to the above-described uses, the promotional tokens of the present invention can be used by cities and municipalities to entice visitors and tourists. Furthermore, the promotional tokens of the present invention can be given out by charities for contributions and used promotionally thereafter for various goods and services. For example, a restaurant or group of restaurants may agree to offer meals or discounts in exchange for, or in exchange for reading the serialized data from, tokens that could be given out by a charity for contributions. Tracking the data would aid in determining commercial success of the promotion for the restaurant(s).

In a simpler alternative use for charitable purposes, entities issuing or distributing tokens can donate a portion of the value to a charity after the tokens are exchanged for goods or services.

It is also possible to embed the tokens within a product or otherwise make the tokens an integral part of a product rather than using the gift package assemblies described herein.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A method of promoting a commercial activity which comprises the steps of:
a) identifying customers to attract to a commercial activity;
b) distributing at least one token to each of the identified customers, each of said distributed tokens having a true cash value and being substantially identical to similar tokens used as cash within the situs where the commercial activity takes place; and
c) allowing the identified customers to which the tokens are distributed to participate in the commercial activity within the situs.

2. A method of promoting a commercial activity according to claim 1, wherein the distributed tokens further are provide with serialized data and the method further includes the step of collecting the tokens in step c), recording the serialized data provided on the tokens in steps b) and c) and correlating information regarding the distribution and collection of the individual tokens.

3. A method of promoting a commercial activity according to claim 1, wherein the commercial activity comprises gambling at a casino and the tokens comprises at least one of gambling tokens or chips used at the casino.

4. A method of promoting a commercial activity according to claim 1, wherein the tokens are distributed to the identified customers in a gift package assembly.

5. A method of promoting a commercial activity according to claim 1, wherein the tokens are handed out to the identified customers.

6. A method of promoting a commercial activity according to claim 1, wherein the tokens are mailed to the identified customers.

7. A method of promoting a commercial activity which comprises the steps of:
a) identifying customers to attract to a commercial activity;
b) distributing at least one token to each of the identified customers, each of said distributed tokens provided with serialized data and being exchangeable for value for the commercial;
c) allowing the identified customers to which the tokens are distributed to participate in the commercial activity; and
d) recording the serialized data provided on the tokens in steps b) and c) and correlating information regarding the distribution and collection of the individual tokens.

8. A method of promoting a commercial activity according to claim 7, wherein the tokens are exchanged for a cash equivalent.

9. A method of promoting a commercial activity according to claim 7, wherein the commercial activity comprises one of purchasing items, obtaining services and entertainment.

10. A method of promoting a commercial activity according to claim 7, wherein the tokens are distributed to the identified customers in a gift package assembly.

11. A method of promoting a commercial activity according to claim 7, wherein the tokens are handed out to the identified customers.

12. A method of promoting a commercial activity according to claim 7, wherein the tokens are mailed to the identified customers.

13. A system for obtaining data applied to tokens which comprises:
a mechanical system for receiving and presenting tokens to an imaging station;
an imaging system for capturing images of the tokens when they are positioned at the imaging station; and
a data processor for receiving images of the tokens from the imaging system and identifying the data that is applied to the tokens; and
means for storing and correlating the identified data.

14. A system for obtaining data applied to tokens according to claim 13, wherein the tokens comprise one of casino chips and slot machine tokens.

15. A system for obtaining data applied to tokens according to claim 13, wherein the identified data is correlated for determining and developing marketing strategies in which the tokens are used.

16. A method of tracking the dispersement and use of tokens that having tracking data applied there to which comprises the steps of:
obtaining tokens that were distributed and dispersed;
feeding the obtained tokens into a mechanical system that presents the tokens to an imaging station;
capturing images of the tokens when they are positioned at the imaging station;
sending the captured images of the tokens to a data processor and identifying the data that is applied to the tokens; and
correlating the identified data to determine and develop marketing strategies based on the manner in which the tokens were distributed and dispersed.

17. A method of tracking the dispersement and use of tokens that having tracking data applied there to according to claim 16, wherein the tokens comprise one of casino chips and slot machine tokens.

18. A method of tracking the dispersement and use of tokens that having tracking data applied there to according to claim 16, wherein the tokens were distributed during a promotional marketing program.
